(19) United States
(12) Patent Application Publication
(10) Pub. No.: US 2021/0162961 A1
(43) Pub. Date: Jun. 3, 2021

(54) AUTOMATED GUIDED ROBOT SYSTEM

(71) Applicant: FANUC CORPORATION, Yamanashi (JP)

(72) Inventors: Youhei YAMAGUCHI, Yamanashi (JP); Kazutaka NAKAYAMA, Yamanashi (JP)

(73) Assignee: FANUC CORPORATION, Yamanashi (JP)

(21) Appl. No.: 17/076,104

(22) Filed: Oct. 21, 2020

(30) Foreign Application Priority Data
Nov. 28, 2019 (JP) 2019-214901

(51) Int. Cl. B60S 5/00; B25J 5/00; B25J 19/02; B25J 15/04; G05D 1/00; G05D 1/02

(52) U.S. Cl. CPC B60S 5/00; B25J 5/007; G05D 1/0212; B25J 15/04; G05D 1/0088; B25J 19/023

(57) ABSTRACT

An automated guided robot system includes an automated guided vehicle, a robot mounted on the automated guided vehicle, and a sensor mounted on the robot and capable of detecting statuses of maintenance parts of the automated guided vehicle. The robot has a motion range that enables the robot to place the sensor at positions from which the statuses of the maintenance parts of the automated guided vehicle are detectable. Accordingly, the necessity for performing maintenance of multiple maintenance parts can be detected while reducing the number of sensors mounted thereon.

### CROSS-REFERENCE TO RELATED APPLICATIONS

This application is based on and claims priority to Japanese Patent Application No. 2019-214901 filed on Nov. 28, 2019, the content of which is incorporated herein by reference in its entirety.

### FIELD

The present disclosure relates to an automated guided robot system.

### BACKGROUND

There is a known arranging robot that travels with a manipulator mounted thereon, the manipulator having a hand unit equipped with a sensor, such as a laser sensor or a camera (for example, Japanese Unexamined Patent Application, Publication No. 2012-139792).

When this arranging robot moves, the manipulator is actuated to perform measurement with the sensor so that the arranging robot is automatically controlled based on the acquired information. When an object is to be gripped by the manipulator, the manipulator is actuated to perform measurement with the sensor, and the gripping task of the manipulator is automatically controlled based on the acquired information.

### SUMMARY

An aspect of the present disclosure provides an automated guided robot system that includes an automated guided vehicle, a robot mounted on the automated guided vehicle, and a sensor mounted on the robot and capable of detecting statuses of multiple maintenance parts of the automated guided vehicle, in which the robot has a motion range that enables the robot to place the sensor at positions from which the statuses of the maintenance parts of the automated guided vehicle are detectable.

### BRIEF DESCRIPTION OF DRAWINGS

FIG. 1 is a perspective view of an automated guided robot system according to one embodiment of the present disclosure.

FIG. 2 is a schematic plan view illustrating one example of a travel path of an automated guided vehicle of the automated guided robot system illustrated in FIG. 1.

FIG. 3 is a perspective view illustrating one example of the posture of a robot that detects the status of an obstacle sensor with the automated guided robot system illustrated in FIG. 1.

FIG. 4 is a perspective view illustrating one example of the posture of the robot that detects the status of tires with the automated guided robot system illustrated in FIG. 1.

FIG. 5 is a perspective view illustrating one example of the posture of the robot that detects the status of an indicator lamp with the automated guided robot system illustrated in FIG. 1.

FIG. 6 is a block diagram illustrating a controller of the automated guided robot system illustrated in FIG. 1.

FIG. 7 is a perspective view illustrating one example of the posture of the robot that detects vibrations with an acceleration sensor in the automated guided robot system illustrated in FIG. 1.

### DETAILED DESCRIPTION OF EMBODIMENTS

An automated guided robot system 1 according to one embodiment of the present disclosure will now be described with reference to the drawings.

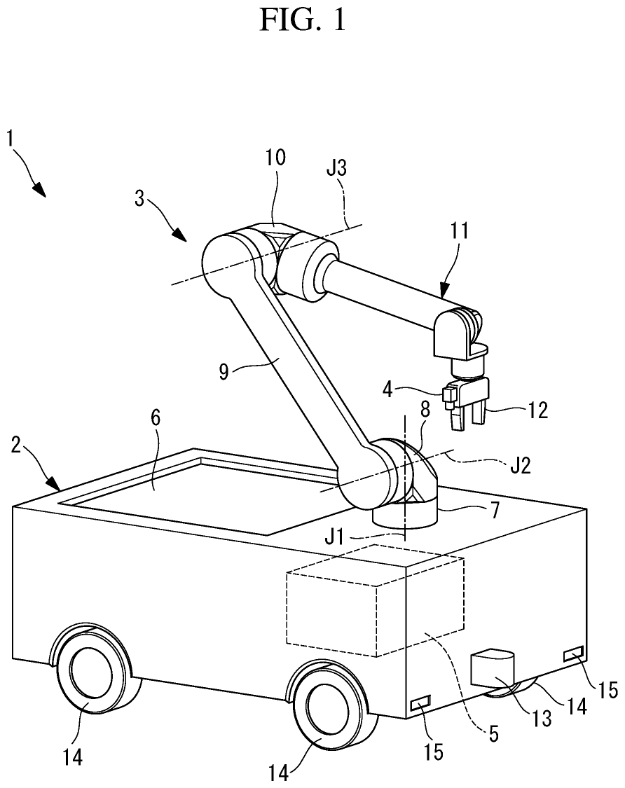

As illustrated in FIG. 1, the automated guided robot system 1 according to this embodiment is equipped with an autonomous automated guided vehicle 2 that can travel on a road; a robot 3 mounted on the automated guided vehicle 2; a sensor 4 mounted on the robot 3, and a controller (control unit) 5 that is mounted on the automated guided vehicle 2 and controls the robot 3 and the automated guided vehicle 2.

The automated guided vehicle 2 is a steerable four-wheel vehicle having an upper surface on which the robot 3 is mounted. A table 6 on which a workpiece and the like are loaded is disposed within the motion range of the robot 3.

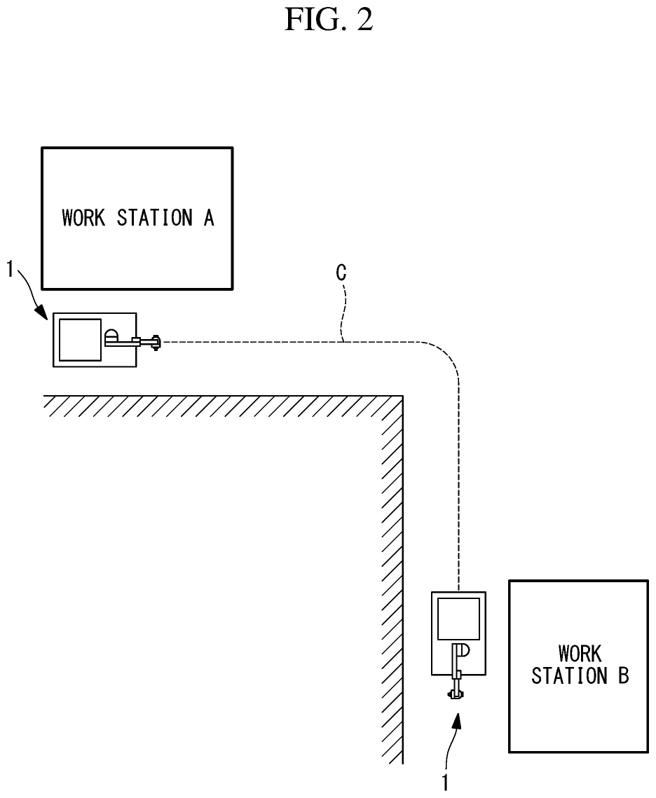

As illustrated in FIG. 2, the automated guided vehicle 2 is guided along a predetermined travel path C between work stations A and B in order for the robot 3 to perform tasks at these work stations A and B. The travel path C is stored in the controller 5, and the automated guided vehicle 2 is caused to move along the travel path C by a desired method such as GPS, SLAM, or magnetic induction.

The robot 3 is, for example, a six-axis articulated robot. The robot 3 is equipped with a base 7 fixed to the upper surface of the automated guided vehicle 2, and a swivel barrel 8 rotatably supported relative to the base 7 about a vertical first axis J1. The robot 3 is also equipped with a first arm 9 rotatably supported relative to the swivel barrel 8 about a horizontal second axis J2, and a second arm 10 rotatably supported relative to the first arm 9 about a third axis J3 parallel to the second axis J2. Moreover, the robot 3 is equipped with a three-axis wrist unit 11 at the distal end of the second arm 10.

A hand 12, which is a tool that performs a task such as gripping a workpiece, is attached to the distal end of the wrist unit 11 of the robot 3. The wrist unit 11 may be positioned at any desired three-dimensional position within the motion range by combining the movements of the swivel barrel 8 relative to the base 7, the first arm 9 relative to the swivel barrel 8, and the second arm 10 relative to the first arm 9. In addition, the position of the hand 12 can be moved as desired by actuating the three-axis wrist unit 11.

The sensor 4 is, for example, a camera that acquires a two-dimensional image. In this embodiment, the sensor 4 is fixed to the hand 12. In this manner, when the hand 12 is moved to a desired posture at the desired three-dimensional position by the operation of the robot 3, the sensor 4 can also be arranged at a desired posture at the desired three-dimensional position.

In this embodiment, the robot 3 has a motion range with which the sensor 4 can be arranged to face multiple maintenance parts 13, 14, and 15 of the automated guided vehicle 2. Examples of the maintenance parts include an obstacle sensor 13 installed on a front surface of the automated guided vehicle 2 to detect obstacles and the like in front of the traveling automated guided vehicle 2 in the travelling direction. Other examples of the maintenance parts include an indicator lamp 15 and four tires 14.

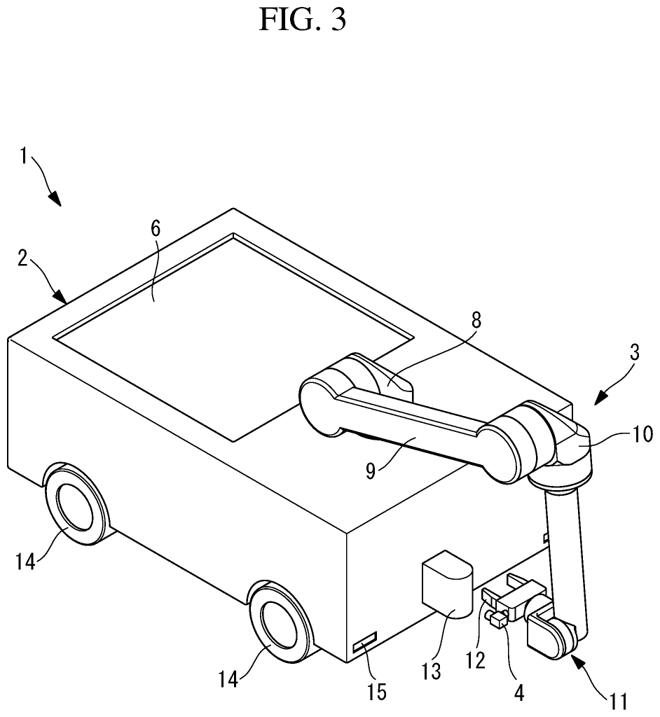

In order to detect the status of the obstacle sensor 13, the robot 3 is moved to the posture illustrated in FIG. 3 so that the sensor 4 faces the obstacle sensor 13 and the obstacle sensor 13 is placed within the detection range of the sensor 4. In this manner, the image of the appearance of the obstacle sensor 13 can be acquired through the sensor 4.

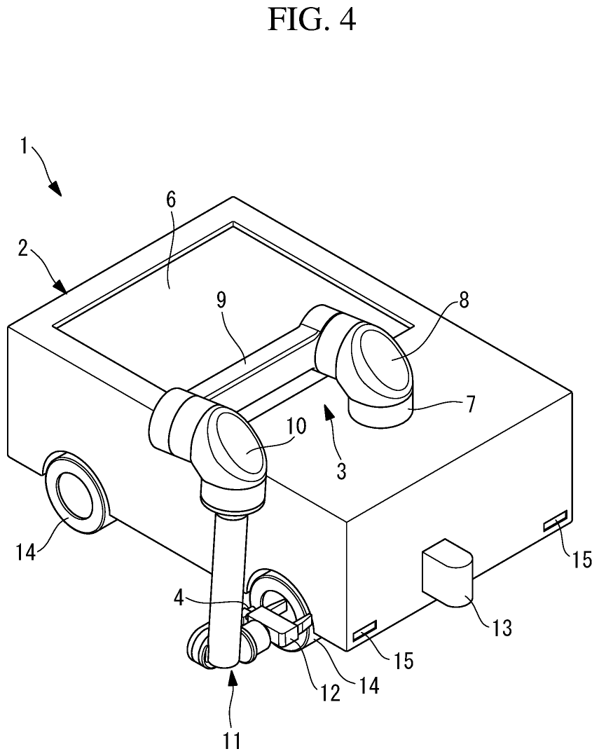

In order to detect the statuses of the tires 14, the robot 3 is moved, for example, to the posture illustrated in FIG. 4. The sensor 4 is faced with each of the tires 14 to place each of the tires 14 within the detection range of the sensor 4. In this manner, images of the appearances of each of the tires 14 can be acquired through the sensor 4.

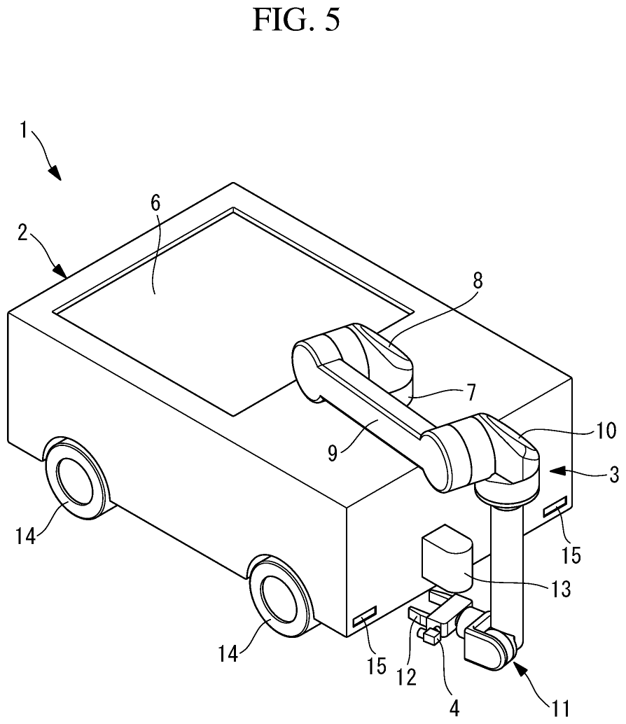

In order to detect the status of the indicator lamp 15, the robot 3 is moved to the posture illustrated in FIG. 5 so that the sensor 4 faces the indicator lamp 15 and the indicator lamp 15 is placed within the detection range of the sensor 4, and the indicator lamp 15 is turned ON and OFF.

In this manner, images of the indicator lamp 15 when a turn-on command is output and when a turn-off command is output can be acquired through the sensor 4.

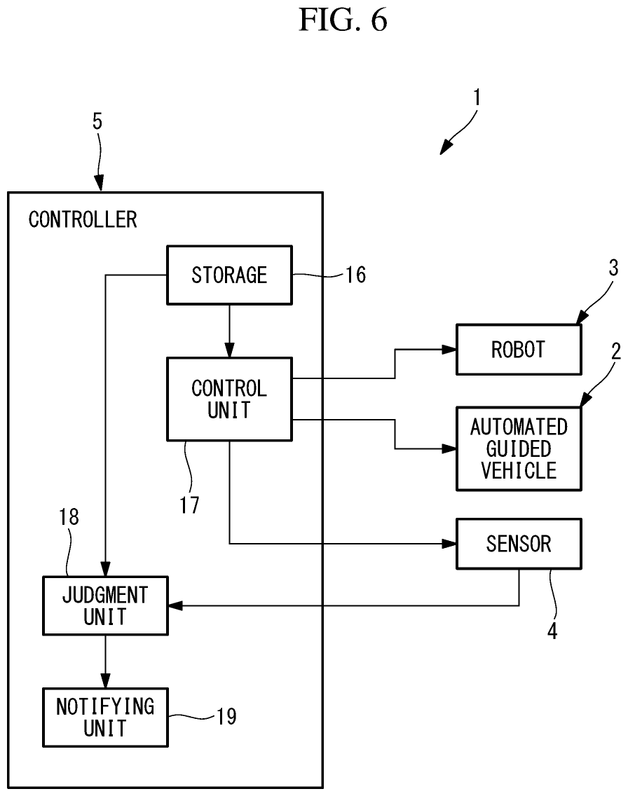

As illustrated in FIG. 6, the controller 5 includes a storage 16 that stores a program and the like, and a control unit 17 that controls the robot 3 and the automated guided vehicle 2 according to the program stored in the storage 16. In addition, the controller 5 also includes a judgment unit 18 that judges whether maintenance is necessary based on the images acquired through the sensor 4, and a notifying unit 19 that issues a notification when it is judged that the maintenance is necessary. The storage 16 is constituted by a memory, and the control unit 17 and the judgment unit 18 are constituted by a processor and a memory.

Examples of the statuses of the maintenance parts 13, 14, and 15 include whether there are dents or deformation in the obstacle sensor 13, whether there is wear or a puncture in the tires 14, whether the indicator lamp 15 is damaged, and whether the indicator lamp 15 can display an indicator as commanded.

According to the program stored in the storage 16, the control unit 17 actuates the robot 3 to each of the positions for maintenance described above on a regular basis, actuates the sensor 4, and actuates the indicator lamp 15 of the automated guided vehicle 2. The judgment unit 18 then judges whether the maintenance parts 13, 14, and 15 require maintenance based on the images acquired through the sensor 4.

For example, when the status of the maintenance parts 13, 14, and 15 detected through the sensor 4 is the wear status of the tires 14, the judgment unit 18 processes the image to extract the groove depth of the treads or the size of the slip sign, for example. Then the judgment unit 18 compares the extracted status with the threshold value stored in the storage 16 so as to judge whether maintenance is necessary.

Meanwhile, when the status of the maintenance parts 13, 14, and 15 detected through the sensor 4 is whether there are dents or deformation in the obstacle sensor 13, whether there is a puncture in the tires 14, whether the indicator lamp 15 is damaged, or whether the indicator lamp 15 can display as commanded, the judgment unit 18 can judge the necessity for maintenance by using the images.

For example, the judgment unit 18 may compare the acquired image with an image of a normal status stored in the storage 16 and judge whether the maintenance is necessary. Alternatively, the judgment unit 18 may judge whether the maintenance is necessary by inputting the acquired image into a learned model generated by machine learning in advance.

The timing for performing the operation of confirming the necessity for maintenance of the maintenance parts 13, 14, and 15 may be set based on the cumulative time counted by a timer (not illustrated) or may be set at a start or end time of daily operation.

The notifying unit 19 may be any desired means that is capable of informing externally the notification of maintenance necessity, and examples thereof include a monitor, a speaker, and an indicator lamp.

The operation of the automated guided robot system 1 according to this embodiment having the aforementioned features will now be described.

Described below is the case in which the automated guided robot system 1 of this embodiment has reached the timing at which the operation of confirming the necessity for maintenance is to be performed.

In this case, the controller 5 actuates the robot 3, and, as illustrated in FIGS. 3 to 5, the maintenance parts 13, 14, and 15 are placed within the detection range of the sensor 4 attached to the hand 12. In this state, images of the appearances of the maintenance parts 13, 14, and 15 are acquired through the sensor 4 and sent to the judgment unit 18.

Next, based on the acquired images, whether maintenance is necessary is judged by the judgment unit 18, and when it is judged that maintenance is necessary, a notification is issued from the notifying unit 19.

According to the automated guided robot system 1 of this embodiment, since the statuses of the maintenance parts 13, 14, and 15 are detected by using the sensor 4 mounted on the robot 3, the sensor 4 that detects the status does not have to be provided for each of the maintenance parts 13, 14, and 15. In other words, the statuses of the maintenance parts 13, 14, and 15 can be detected by using a single sensor 4. This offers an advantage in that the cost of the automated guided robot system 1 can be reduced.

In addition, since the robot 3 mounted on the automated guided vehicle 2 places the sensor 4 at positions from which the statuses of the maintenance parts 13, 14, and 15 are detectable, whether the maintenance is necessary can be confirmed without designating the time and place for the automated guided vehicle 2 that moves over a wide range.

In this embodiment, the sensor 4 is constituted by a camera, and two-dimensional images of the appearances of the maintenance parts 13, 14, and 15 are acquired. Alternatively, a camera that can acquire three-dimensional images or a sensor 4 other than a camera may be used. For example, a distance sensor that uses a laser beam may be employed.

In this embodiment, the obstacle sensor 13, the indicator lamp 15, and four tires 14 are used as the examples of the maintenance parts. In addition, a contact sensor, such as a bumper, may be installed as the maintenance part on the automated guided vehicle 2.

In such a case, the robot 3 presses the contact sensor with the second arm 10, the wrist unit 11, or the hand 12, and the motor torque of the robot 3 or a force sensor mounted on the hand 12 is used to confirm the pressing. When the pressing is confirmed by the robot 3 side and the pressing is also detected with the contact sensor on the automated guided vehicle 2 side, it is judged that maintenance is not necessary.

Alternatively, an acceleration sensor or a microphone may be employed as the sensor 4. In this case, in particular, abnormities in the driving system (a motor or a reducer) of the automated guided vehicle 2 can be detected through the amplitude of vibrations or the intensity of abnormal noise.

In such a case, detection needs to be conducted while running the driving system of the automated guided vehicle 2; however, detection conducted while the automated guided vehicle 2 is travelling on the road is susceptible to disturbances caused by road conditions. Thus, preferably, detection of the statuses of the maintenance parts 13, 14, and 15 is conducted after the control unit 17 commands the automated guided vehicle 2 to move the tires 14 to a place where idling can be performed, such as by jacking up the vehicle.

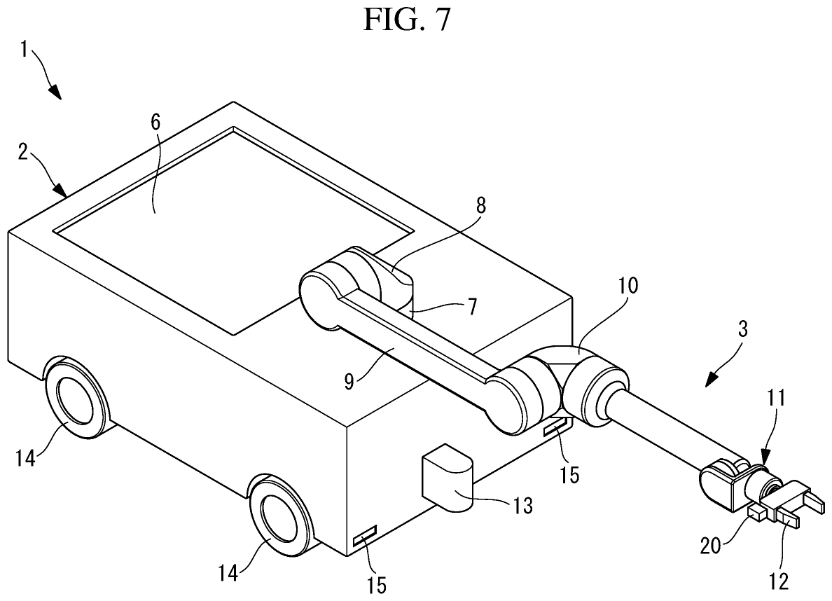

When abnormal noise is to be detected with a microphone, the robot 3 may be actuated to bring the microphone attached to the distal end of the robot 3 close to the driving system. In addition, when vibrations are to be detected with the acceleration sensor 20, as illustrated in FIG. 7, the arms 9 and 10 of the robot 3 are extended as much as possible to amplify the amplitudes of vibrations at the position of the acceleration sensor 20 attached to the distal end of the robot 3. In this manner, the sensitivity of the sensors 4 and 20 can be improved, and the statuses of the maintenance parts 13, 14, and 15 can be detected highly accurately.

Moreover, as described above, when different types of statuses need to be detected, such as when the appearance needs to be detected for some of the maintenance parts 13, 14, and 15 and vibrations or abnormal noise needs to be detected for other maintenance parts 13, 14, and 15, different types of sensors 4 can be mounted on the automated guided vehicle 2. In such a case, a sensor changing device similar to an automatic tool changer (ATC) for the sensor 4 may be installed on the robot 3, and the sensors 4 may be changed in accordance with the maintenance parts 13, 14, and 15 from which the status is to be detected.

In this embodiment, the judgment unit 18 for judging whether the maintenance of the maintenance parts 13, 14, and 15 is necessary is provided; alternatively, a maintenance time estimation unit (not illustrated) that estimates the time when maintenance of the maintenance parts 13, 14, and 15 becomes necessary may be provided. In addition, the notifying unit 19 may be an estimated time notifying unit that issues a notification of the time estimated by the maintenance time estimation unit to the outside through a display on a monitor, a sound, the color of an indicator lamp, or the like.

In addition, the maintenance time estimation unit may estimate the maintenance time by inputting the statuses of the maintenance parts 13, 14, and 15 acquired through the sensor 4 into a learned model generated by machine learning in advance.

In this embodiment, a six-axis articulated robot is employed as the robot 3; alternatively, a seven-axis articulated robot or a different type of robot may be employed.

Moreover, although an example in which the sensor 4 is fixed to the hand 12 is described, the sensor 4 may be fixed to the swivel barrel 8, the first arm 9, the second arm 10, or the wrist unit 11.

When the sensor 4 is fixed to the swivel barrel 8, an adapter may be used to offset the fixed position of the sensor 4 from the top surface of the automated guided vehicle 2 so that the sensor 4 protrudes from the top surface and the statuses of the maintenance parts 13, 14, and 15 can be detected.

In this embodiment, an example in which the robot 3 and the automated guided vehicle 2 are controlled by a single controller 5 is described; alternatively, multiple controllers 5 may be provided, one of which controls the robot 3 and another one of which controls the automated guided vehicle 2.

Alternatively, in this embodiment, the robot 3 may perform the maintenance operation automatically.

Specifically, when a loose bolt is detected, by a camera serving as the sensor 4, from the maintenance target in the automated guided robot system 1, the ATC changes the hand 12 to a hand for tightening a bolt and performs retightening of the loose bolt.

In addition, when contamination is detected by a camera serving as the sensor 4 from the maintenance target in the automated guided robot system 1, the ATC changes the hand 12 to a hand for cleaning and performs cleaning of the contaminated region.

Moreover, when changing of parts has become necessary as a result of maintenance judgment, the ATC changes the hand 12 so that the parts can be changed to spare parts stored in the spare part storage or the like.

1. An automated guided robot system comprising:
an automated guided vehicle;
a robot mounted on the automated guided vehicle; and
a sensor mounted on the robot and capable of detecting statuses of a plurality of maintenance parts of the automated guided vehicle,
wherein the robot has a motion range that enables the robot to place the sensor at positions from which the statuses of the maintenance parts of the automated guided vehicle are detectable.

2. The automated guided robot system according to claim 1, further comprising a judgment unit that judges whether maintenance of each of the maintenance parts is necessary based on the statuses detected with the sensor.

3. The automated guided robot system according to claim 2, further comprising a notifying unit that issues a notification of maintenance necessity when the judgment unit judges that maintenance is necessary.

4. The automated guided robot system according to claim 1, wherein the sensor is a camera and the sensor detects appearance statuses of the maintenance parts.

5. The automated guided robot system according to claim 1, wherein the robot is equipped with a sensor changing device that changes the sensor in response to a status type of the maintenance parts to be detected.

6. The automated guided robot system according to claim 1, further comprising a maintenance time estimation unit that estimates a maintenance time of each of the maintenance parts based on the statuses detected with the sensor.

7. The automated guided robot system according to claim 6, further comprising a maintenance time notifying unit that issues a notification of the maintenance time estimated by the maintenance time estimation unit.
